(19) United States
(12) Patent Application Publication
(10) Pub. No.: US 2022/0300639 A1
(43) Pub. Date: Sep. 22, 2022

(54) WEB APPLICATION FIELD LEVEL ENCRYPTION FOR SENSITIVE DATA ELEMENTS

(71) Applicant: Capital One Services, LLC, McLean, VA (US)

(72) Inventors: Jon B. BELLMAN, JR., Little Elm, TX (US); Neha PATEL, Carrollton, TX (US)

(73) Assignee: Capital One Services, LLC, McLean, VA (US)

(21) Appl. No.: 17/202,853

(22) Filed: Mar. 16, 2021

(51) Int. Cl. G06F 21/62; H04L 9/30

(52) U.S. Cl. CPC G06F 21/6245; H04L 9/3066

(57) ABSTRACT

Systems for dynamic detection and encryption of sensitive data are disclosed. The sensitive data may be dynamically detected (i.e., detected in real-time) as it is entered into fields of a software application frontend user interface (UI). The application frontend UI may be implemented using a web browser. Upon detection of the sensitive data, in some embodiments, the application can request a unique public key from a key rotation service of a cloud computing environment. The sensitive data may be encrypted based on the public key received from the key rotation service. The application frontend UI can request a unique public key from an application backend for frontend (BFF). The sensitive data may be encrypted based on the public key received from the application BFF.

### TECHNICAL FIELD

Embodiments relate to systems and methods for data encryption, specifically dynamic encryption of sensitive data elements entered into application frontend user interfaces.

### BACKGROUND

Sensitive data, for example personal identifying information (PII), passwords, account numbers, etc., is provided to companies regularly. The source of this data may be varied, and can include clients, employees, third-party services, etc. Various laws and regulations, for example the General Data Protection Regulation (GDPR) of the European Union, and the California Consumer Privacy Act (CCPA) of the State of California in the USA, require companies to implement systems to secure such sensitive data. Thus, it is vitally important for companies to secure this data.

Sensitive data may be provided via various channels. One of the most common channels is through software, such as a web application using a web interface (e.g., a web browser). Clients, employees, or third-parties can use the web interface to input the sensitive data into the software application. For example, text boxes or other fields are typically used to provide social security numbers, bank account numbers, or other sensitive data. Once entered, this data is typically transmitted to company servers where it is encrypted for secure storage and use. Encryption techniques that may be employed to secure the data include public key infrastructure (PKI) encryption, where public-private key pairs are used to encrypt and decrypt the data. Often the same keys are used to encrypt/decrypt different pieces of data (in other words, the keys remain static).

The aforementioned scheme is not ideal because sensitive data may be compromised at various levels prior to being encrypted. For example, the sensitive data may be compromised in the process of transmission to company servers, prior to the sensitive data being encrypted. This can happen, for example, if the data is intercepted by nefarious actors. Thus, systems and methods are needed to dynamically detect and encrypt sensitive data at the source (i.e., the interface where the data is input). Moreover, it is desirable that any method used to encrypt/decrypt sensitive data uses unique encryption keys for each piece of sensitive data, so as to provide an added layer of security, and to lower the probability that compromised keys may be used to decrypt other sensitive data. Methods and systems are needed to address these problems.

### SUMMARY

Embodiments disclosed herein provide systems and methods for dynamic encryption of sensitive data. The systems and methods improve conventional systems by implementing an architecture and methods that allows for encryption of sensitive data from the time it is input into a system. In embodiments, the encryption occurs at an application frontend, and in real-time, as the sensitive data is input. As a result, sensitive data can be secured from the moment it enters the system minimizing the risk of data breaches. In embodiments, the systems can perform the aforementioned functionality by implementing methods to dynamically detect the sensitive data from text input into a field of an application user interface (UI) running on a browser. In embodiments, based on detecting the sensitive data, a request may be generated for a unique public key from a key rotation service of a cloud computing environment. In embodiments, the request may be transmitted to the key rotation service. In embodiments, based on receipt of the request, the key rotation service can transmit the public key to the application frontend. In embodiments, the application frontend can receive the public key from the key rotation service. In embodiments, an encrypted version of the sensitive data may be generated using the unique public key. In a number of embodiments, the encrypted version of the sensitive data may be transmitted to an application BFF for further processing, as shown in.

In embodiments, the systems can perform the aforementioned functionality by implementing methods to dynamically detect the sensitive data from text input into a field of an application user interface (UI) running on a browser. In embodiments, based on detecting the sensitive data, a request may be generated for a unique public key from an application BFF. In embodiments, the request may be transmitted to the application BFF. In embodiments, based on receipt of the request, the application BFF can transmit the public key to the application frontend. In embodiments, the application frontend can receive the public key from the application BFF. In embodiments, an encrypted version of the sensitive data may be generated using the unique public key. In a number of embodiments, the encrypted version of the sensitive data may be transmitted to the application BFF for further processing.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the pertinent art to make and use the disclosure.

FIG. 1 is a system for dynamic encryption of sensitive data using an encryption key rotation service of a cloud computing environment in an embodiment of the present disclosure.

FIG. 2 is a system for dynamic encryption of sensitive data where encryption keys are provided by an application backend for frontend (BFF) in an embodiment of the present disclosure.

FIG. 3 is an example method of operating the system for dynamic encryption of sensitive data using the encryption key rotation service of the cloud computing environment in an embodiment of the present disclosure.

FIG. 4 is an example method of operating the system for dynamic encryption of sensitive data where encryption keys are provided by the application BFF in an embodiment of the present disclosure.

FIG. 5 is an example architecture of the components implementing the systems for dynamic encryption of sensitive data in an embodiment of the present disclosure.

### DETAILED DESCRIPTION

Embodiments disclosed herein relate to systems that perform steps to enable dynamic encryption of sensitive data using unique and ephemeral public-private key pairs. In embodiments, the sensitive data may be dynamically detected (i.e., detected in real-time) as it is entered into fields of a software application frontend user interface (UI). In a number of embodiments, the application frontend UI may be implemented using a web browser. In a number of embodiments, the sensitive data may be encrypted based on the application requesting a unique public key from a key rotation service of a cloud computing environment. In a number of embodiments, the key rotation service can use PKI technology to generate unique public-private key pairs to enable encryption of the sensitive data at the application frontend, and later decryption of the sensitive data at the application backend.

In a number of embodiments, the sensitive data may be encrypted at the application frontend by having the application frontend request a unique public key from an application backend for frontend (BFF), rather than from the key rotation service. The application BFF refers to a layer between the application frontend and any backend systems used by the application to perform its functions. The application BFF can interface with the other backend systems such as services of a cloud computing environment, to facilitate the functioning of the application. In a number of embodiments, the application BFF can implement functions using PKI technologies to generate unique public-private key pairs to enable the encryption of the sensitive data at the application frontend, and later decryption of the sensitive data at the application backend.

Embodiments disclosed herein allow the aforementioned functionality by disclosing a system that performs steps to dynamically detect the sensitive data from text input into a field of the application UI running on a browser. Based on detecting the sensitive data, the application frontend can generate a request for a unique public key to be received from a public key service of a cloud computing environment. The request may be transmitted to the public key service. Based on the request, the public key service can transmit, and the application frontend can receive, the unique public key from the public key service. Based on receiving the unique public key, the application frontend can generate an encrypted version of the sensitive data using the unique public key. The application frontend can further transmit the encrypted version of the sensitive data to an application BFF for further processing.

Further embodiments disclosed herein enable the aforementioned functionality by disclosing a system that performs steps to dynamically detect the sensitive data from text input into a field of the application UI running on a browser. Based on detecting the sensitive data, the application frontend can generate a request for a unique public key from the application BFF. The request may be transmitted to the application BFF. Based on the request, the application BFF can transmit, and the application frontend can receive, the unique public key from the application BFF. Based on receiving the unique public key, the application frontend can generate an encrypted version of the sensitive data using the unique public key. The application frontend can further transmit the encrypted version of the sensitive data to the application BFF for further processing.

The following embodiments are described in sufficient detail to enable those skilled in the art to make and use the disclosure. It is to be understood that other embodiments are evident based on the present disclosure, and that system, process, or mechanical changes may be made without departing from the scope of an embodiment of the present disclosure.

In the following description, numerous specific details are given to provide a thorough understanding of the disclosure. However, it will be apparent that the disclosure may be practiced without these specific details. In order to avoid obscuring an embodiment of the present disclosure, some well-known circuits, system configurations, architectures, and process steps are not disclosed in detail.

The drawings showing embodiments of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the disclosure may be operated in any orientation.

The term “module” or “unit” referred to herein may include software, hardware, or a combination thereof in an embodiment of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The term “service” or “services” referred to herein can include a collection of modules or units. A collection of modules or units may be arranged, for example, in software or hardware libraries or development kits in an embodiment of the present disclosure in accordance with the context in which the term is used. For example, the software or hardware libraries and development kits may be a suite of data and programming code, for example pre-written code, classes, routines, procedures, scripts, configuration data, or a combination thereof, that may be called directly or through an application programming interface (API) to facilitate the execution of functions of the system.

The modules, units, or services in the following description of the embodiments may be coupled to one another as described or as shown. The coupling may be direct or indirect, without or with intervening items between coupled modules, units, or services. The coupling may be by physical contact or by communication between modules, units, or services.

### System Overview and Function

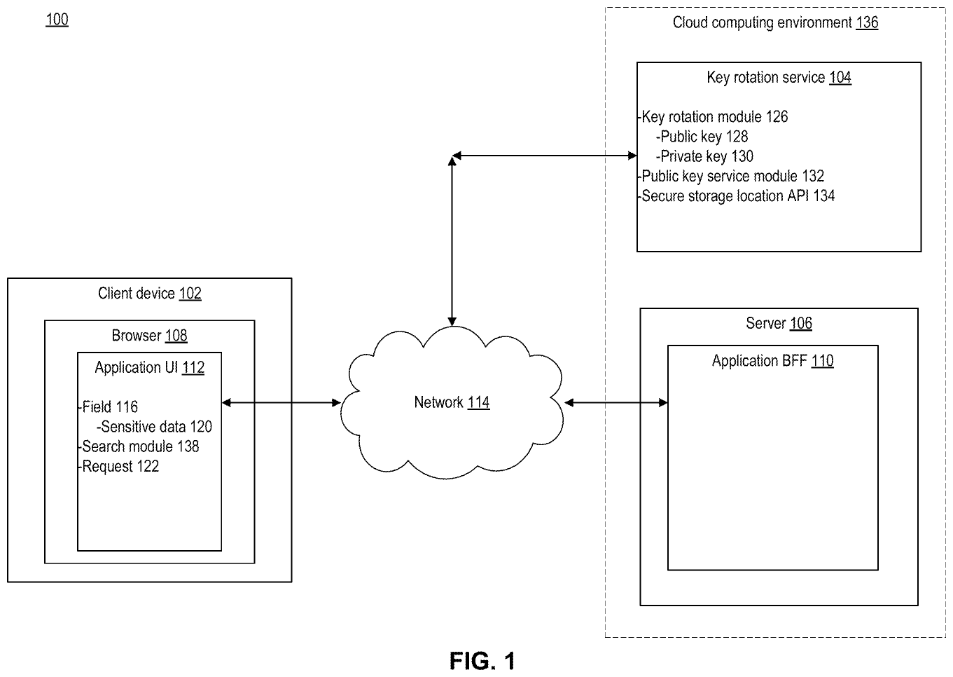

FIG. 1 shows a system 100 for dynamic encryption of sensitive data 120 in an embodiment of the present disclosure. In a number of embodiments, system 100 can use a key rotation service 104 of a cloud computing environment 136 to enable dynamic encryption. The key rotation service 104 refers to a service of a cloud computing environment 136 that can use PKI technology to generate unique public-private key pairs used to encrypt/decrypt the sensitive data 120. Key rotation services that can be used to implement key rotation service 104 are described in U.S. patent application Ser. No. 17/201,747, the contents of which is incorporated herein in its entirety herein. How the key rotation service 104 may be used to enable the dynamic encryption of sensitive data 120 in the present disclosure will be discussed further below.

In a number of embodiments, system 100 can comprise a client device 102, a server 106, and the key rotation service 104. In a number of embodiments, the server 106 and the key rotation service 104 may be part of a cloud computing environment 136. In some embodiments, the cloud computing environment 136 can comprise a variety of centralized or decentralized computing devices. For example, the cloud computing environment 136 may include a mobile device, a laptop computer, a desktop computer, grid-computing resources, a virtualized computing resource, cloud computing resources, peer-to-peer distributed computing devices, servers (including the server 106), a server farm, or a combination thereof. The cloud computing environment 136 may be centralized in a single room, distributed across different rooms, distributed across different geographic locations, or embedded within a network 114.

In a number of embodiments, one or more of the devices comprising the cloud computing environment may be used to implement the key rotation service 104. While the devices comprising the cloud computing environment 136 can couple with the network 114 to communicate with the client device 102, the devices of the cloud computing environment 136 can function as stand-alone devices separate from the client device 102.

In embodiments, the cloud computing environment 136 may be a public or private cloud service. Examples of a public cloud include Amazon Web Services (AWS), IBM Cloud, Oracle Cloud Solutions, Microsoft Azure Cloud, and Google Cloud, as examples. A private cloud refers to a cloud environment similar to a public cloud with the exception that it is operated solely for a single organization. The embodiment shown in FIG. 1 will describe the system 100 assuming the key rotation service 104 and the server 106 are part of the same cloud computing environment 136. System 100, however, does not require this configuration. In some embodiments, the server 106 may be part of a backend system of computers or servers, separate from the cloud environment that the key rotation service 104 is a part of.

In a number of embodiments, the client device 102 may be any of a variety of centralized or decentralized computing devices. For example, the client device 102 may be a mobile device, a laptop computer, or a desktop computer. In a number of embodiments, the client device 102 can function as a stand-alone device separate from other devices of the system 100. Stand-alone can refer to a device being able to work and operate independently of other devices.

In a number of embodiments, the client device 102 can couple to the key rotation service 104 and the server 106 via a network 114. The network 114 may span and represent a variety of networks and network topologies. For example, the network 114 may include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 114. Cable, Ethernet, digital subscriber line (DSL), fiber optic lines, fiber to the home (FTTH), and plain old telephone service (POTS) are examples of wired communication that may be included in the network 114. Further, the network 114 may traverse a number of network topologies and distances. For example, the network 114 may include direct connection, personal area network (PAN), local area network (LAN), metropolitan area network (MAN), wide area network (WAN), or a combination thereof.

In a number of embodiments, the client device 102 can have a software application (also referred to as an application herein) installed thereon. The application refers to any software that may be stored, partially or fully, and executed on the client device 102, to perform some functionality. In a number of embodiments, the application may be a web application, designed pursuant to client-server architectures, and can have portions of its functions executed on the client device 102 and on the server 106. In embodiments where the application is designed pursuant to client-server architectures, it may have a frontend portion, including an application UI 112, installed on the client device 102, and a backend portion comprising an application BFF 110 installed on the server 106. The embodiment shown in FIG. 1 shows this configuration. Both the frontend and backend portions of the application may work together to perform the functions of the application.

In a number of embodiments, the application may include an application UI 112. The application UI 112 refers to a graphical interface from which customers, employees, or third parties may interact with the application, by for example, inputting data into a field 116 of the application UI 112. The field 116 refers to a box, window, or area of the application UI 112 in which inputs may be entered. The field 116 can include areas in which text or numbers may be entered. In some embodiments, the application UI 112 can use a browser 108 to provide the graphics capabilities and interface platform for the application UI 112. The browser 108 can refer to any web browser, for example, Microsoft Internet Explorer™, Microsoft Edge™, Google Chrome™, Apple Safari™, or any similar web browser.

In a number of embodiments, the application may receive inputs via the application UI 112. For example, in a number of embodiments, the application UI 112 can include a field 116 where text inputs, including sensitive data 120, may be input so that the application can perform some function using the sensitive data 120.

By way of example, in a number of embodiments, the application may be a software developed by a company that allows customers or employees to enter sensitive data 120 to facilitate creating accounts, searching for customers, etc. If, for example, the company is a financial services company, the accounts may be a bank account, an investment account, etc. In a number of embodiments, sensitive data 120 such as social security numbers or other PII may be necessary to create such an account. This information may be entered via the application UI 112. In another example, the application may be a software developed to allow employees of the company to search for customers. In a number of embodiments, employees may search for customers based on sensitive data 120, such as social security numbers, account numbers, etc. The aforementioned are examples of what the application may be and are not meant to be limiting.

In a number of embodiments, the application can dynamically detect, at its frontend, for example at the application UI 112, the sensitive data 120 as it is entered, or upon its entry, into a field 116 of the application UI 112. In a number of embodiments, the application can perform the dynamic detection by implementing modules to perform the dynamic detection. For example, a search module 138 may be implemented at the application frontend to dynamically detect the sensitive data 120 as it is entered, or upon its entry.

In a number of embodiments, the search module 138 can enable the dynamic detection by monitoring text input into a field 116 of the application UI 112, and determine, based on a pattern or sequence of the characters input, whether the text input is sensitive data 120. By way of example, the search module 138 can have pre-defined keywords or patterns pre-programmed into its logic, such that if those keywords or patterns are detected in a field 116, the search module 138 can determine that sensitive data 120 has been entered into the field 116. For example, in the case of a social security number, in a number of embodiments, the search module 138 can have keywords, for example “SN:”, “social security number”, or “SSN”, pre-programmed into its logic, such that when those keywords are detected and followed by nine digits, the search module 138 can recognize that the nine digits following the keywords are a social security number. In a number of embodiments, the search module 138, in addition to using keywords, can perform the detection based on pre-defined patterns of characters. For example, in a number of embodiments, the pattern “XXX-XX-XXXX”, where “X” is a positive integer from zero to nine, may be pre-programmed into the logic of the search module 138, such that if text is put into a field 116 and follows that pattern, the search module 138 can determine that the text is a social security number. In a number of embodiments, the application UI 112 can also be configured such that a field 116 may be designated as only having sensitive data 120. For example, if a field 116 is designated as such, any text or numbers entered into the field 116 can automatically be determined to be sensitive data 120. While the aforementioned are given as examples of techniques that may be used to monitor for and detect sensitive data 120, they are exemplary. Based on the type of sensitive data 120 the search module 138 is monitoring for, other keywords and/or patterns may be used.

In a number of embodiments, the search module 138 may be implemented using the Angular web development framework developed by Google LLC, which is an open-source web application framework on which widgets may be developed to implement the search and monitoring functionality of the search module 138. Using Angular, the search module 138 may be implemented as a part of the application frontend and integrated with the application UI 112 to dynamically detect sensitive data 120 as it is entered, or upon its entry.

In a number of embodiments, based on the dynamic detection of the sensitive data 120, the application frontend can generate a request 122 for a unique public key 128 from a public key service module 132 of the key rotation service 104. In a number of embodiments, the request 122 can take the form of an API call to the public key service module 132 requesting the public key 128. A variety of public key service modules and the public keys are described in U.S. patent application Ser. No. 17/201,747, the disclosure of which is hereby incorporated by reference in its entirety.

In a number of embodiments, the application frontend can be configured to generate the request 122 for each instance of sensitive data 120 that is detected. Thus, upon detection of the sensitive data 120, the request 122 can be made for the public key 128 that that particular piece of sensitive data 120 detected and it can be encrypted. In a number of embodiments, the application frontend can be configured to generate the request 122 once all sensitive data 120 has been entered into the field 116. For example, if a field 116 is populated with multiple social security numbers, the application frontend can be configured to generate the request 122 only after all the social security numbers are entered and a customer, employee, or third-party presses a button or graphic asking the application frontend to encrypt the sensitive data 120.

In a number of embodiments, and based on the request 122, public key 128 may be returned to the application frontend as a variable or parameter. In a number of embodiments, once received, the public key 128 may be used by the application frontend to encrypt the sensitive data 120 input into the application UI 112. As a result, an encrypted version of the sensitive data 120 is generated. In a number of embodiments, once the encrypted version of the sensitive data 120 is generated, the application frontend may further mask, as part of the encryption, the sensitive data 120 within the field 116. The masking can result in the sensitive data 120 being hidden with characters or a character string that hides the value of the sensitive data 120. For example, in a number of embodiments, the masking can result in characters such as “*” being put in place of the sensitive data 120 to hide the sensitive data 120. For example, in the case of a social security number, the masking can result in the social security number being replaced by the character string “***-**-****”.

In a number of embodiments, the public key 128 generated by the key rotation service 104 may be linked to a private key 130 that is also generated by the key rotation service 104. In a number of embodiments, the generation of the public key 128 and the private key may be performed by a key rotation module 126. A variety of key rotation modules that can be used to generate the unique public-private key pair are disclosed in U.S. patent application Ser. No. 17/201,747, the disclosure of which is hereby incorporated by reference in its entirety. In a number of embodiments, the public key 128 and the private key 130 may be Elliptic Curve (EC) keys.

In a number of embodiments, once the encrypted version of the sensitive data 120 is generated, the encrypted version of the sensitive data 120 may be transmitted to further components of the system 100 to be processed. For example, in a number of embodiments where the application is a web application with an application BFF 110, the encrypted version of the sensitive data 120 may be transmitted to the application BFF 110 for further processing. In a number of embodiments, the application BFF 110 can receive the encrypted version of the sensitive data 120 and further decrypt the encrypted version of the sensitive data 120 using the unique private key 130 linked to the public key 130. In a number of embodiments, the application BFF 110 can obtain the private key 128 by requesting the private key 130 via a secure storage location API 134 of the key rotation service 104. A variety of secure storage location APIs and techniques for obtaining private keys that can be utilized are disclosed in U.S. patent application Ser. No. 17/201,747, the disclosure of which is hereby incorporated by reference in its entirety In a number of embodiments, once decrypted, the application BFF 110 can perform any number of operations with the sensitive data 120 based on the purpose of the application.

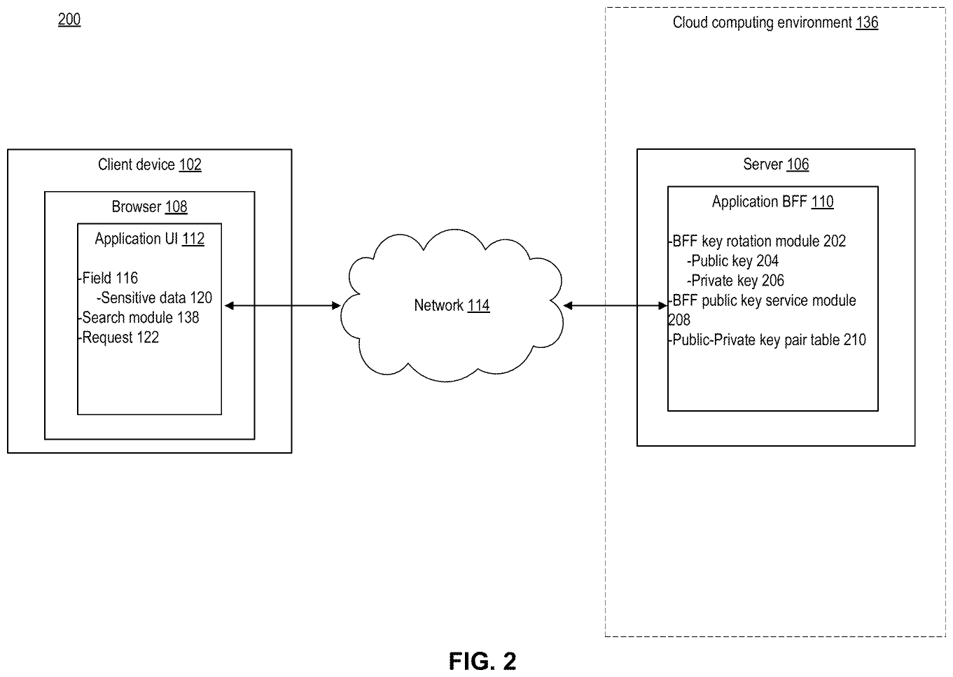

FIG. 2 shows a system 200 for dynamic encryption of sensitive data 120 in an embodiment of the present disclosure. System 200 discloses a number of embodiments where the unique public-private key pair, which in FIG. 2 are shown as public key 204 and private key 206, is provided by the application BFF 110 rather than the key rotation service 104 of FIG. 1. Thus, in system 200, the application frontend rather than generating the request 122 for the public key 204 and transmitting the request 122 to the key rotation service 104, will transmit the request 122 to the application BFF 110. In a number of embodiments, the application BFF 110 can have the same functionality as the key rotation service 104 to generate unique public-private key pairs.

For example, in a number of embodiments, a BFF key rotation module 202 may be implemented within the application BFF 110 and have the same capabilities as the key rotation module 126 to generate public-private key pairs. In a number of embodiments, the BFF key rotation module 202 can generate unique public-private key pairs, for example Elliptic Curve (EC) keys based on the same principles of the key rotation module 126. A variety of techniques for generating key pairs are disclosed in U.S. patent application Ser. No. 17/201,747, the disclosure of which is hereby incorporated by reference in its entirety. In this way, the unique public key 204 and the unique private key 206 may be generated directly by the application itself, bypassing the need to rely on the key rotation service 104 to generate the public-private key pair. By integrating the key generation capabilities within the application BFF 110, the application can have all the encryption/decryption capabilities self-contained so it does not have to rely on a third-party service such as the key rotation service 104. This is beneficial in instances where the third-party service incurs some downtime, is malfunctioning, or otherwise incapable of generating the unique public-private key pairs.

In a number of embodiments, the application BFF 110 can have a BFF public key service module 208 implemented as a part of the application BFF 110. The BFF public key service module 208 can serve the same purpose and function as the public key service module 132. Thus, the BFF public key service module 208 performs the same functions as the public key service module 132, except it functions from within the application BFF 110. In a number of embodiments, the request 122 generated by the application frontend in system 100 may be transmitted to the BFF public key service module 208, which can, based on the request 122, transmit the public key 204 back to the application frontend so it can encrypt the sensitive data 120.

In a number of embodiments, the application BFF 110 can implement a public-private key pair table 210 to track the unique public-private key pairs generated by the BFF key rotation module 202. In a number of embodiments, the public-private key pair table 210 may be a database or data structure used to store the values of the public key 204 and private key 206 pairs that are generated by the BFF key rotation module 202. In a number of embodiments, the application BFF 110 can decrypt the encrypted version of the sensitive data 120 it receives from the application frontend, by determining what public key 204 was used to encrypt the sensitive data 120, and using the linked private key 206 associated with that public key 204, to decrypt the data. This may be done by referencing the public-private key pair table 210. In a number of embodiments, once decrypted, the application BFF 110 can then perform additional processing on the sensitive data 120.

The modules and services described in FIGS. 1 and 2 may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof The non-transitory computer readable medium may be integrated as a part of systems 100 and 200 and/or installed as a removable portion of systems 100 and 200.

It has been discovered that systems 100 and 200 described above significantly improve the state of the art from previous systems for encryption of sensitive data 120 because they introduces novel architecture where sensitive data 120 may be encrypted dynamically at the source where it is entered. Particularly, for web applications with application frontends, the sensitive data 120 may be encrypted as it is entered into the application UI 112. This architecture allows sensitive data 120 to be secured from the instant it enters the company systems via the application UI 112, thus minimizing the risk that the sensitive data 120 will be compromised as it is processed.

Additionally, system 100 allows applications built on, or integrated with, a cloud computing environment 136 to utilize PKI technologies without having to implement any of the PKI infrastructure themselves. This significantly improves development time for client applications because it offloads security functions for the applications to the cloud computing environment 136, thereby simplifying development and implementation of applications built for the cloud computing environment.

Additionally, system 200 provides an implementation that allows applications to incorporate PKI capabilities within the application itself. While this embodiment requires additional implementation steps and software code to implement the PKI capabilities within the application, system 200 provides a benefit that encryption/decryption capabilities may be wholly integrated in the application itself. This allows the application independent capabilities to secure sensitive data 120 without relying on third-party services such as the key rotation service 104. This is beneficial if, for example, the key rotation service 104 cannot provide unique public-private key pairs, incurs some downtime, is malfunctioning, or otherwise is incapable of generating the unique public-private key pairs.

It has been further discovered that the systems 100 and 200 described above significantly improve the state of the art because it implements an encryption mechanism that can provide ephemeral and/or unique public-private key pairs to encrypt/decrypt sensitive data 120. Systems 100 and 200 allow generation of the ephemeral and/or unique public-private key pairs through the key rotation module 126, which generates these ephemeral and/or unique public-private key pairs. Techniques for key rotations that can be used are disclosed in U.S. patent application Ser. No. 17/201,747, the disclosure of which is hereby incorporated by reference in its entirety. As indicated, the BFF key rotation module 202 can implement the same functions but from within the application BFF 110. Having the sensitive data 120 secured via these ephemeral and/or unique public-private key pairs enhances security over sensitive data 120 because it ensures that unique public and private keys are used frequently to secure data, thereby minimizing the ability of any nefarious actors to decrypt sensitive data 120 if any particular sets of keys are compromised.

### Methods of Operation

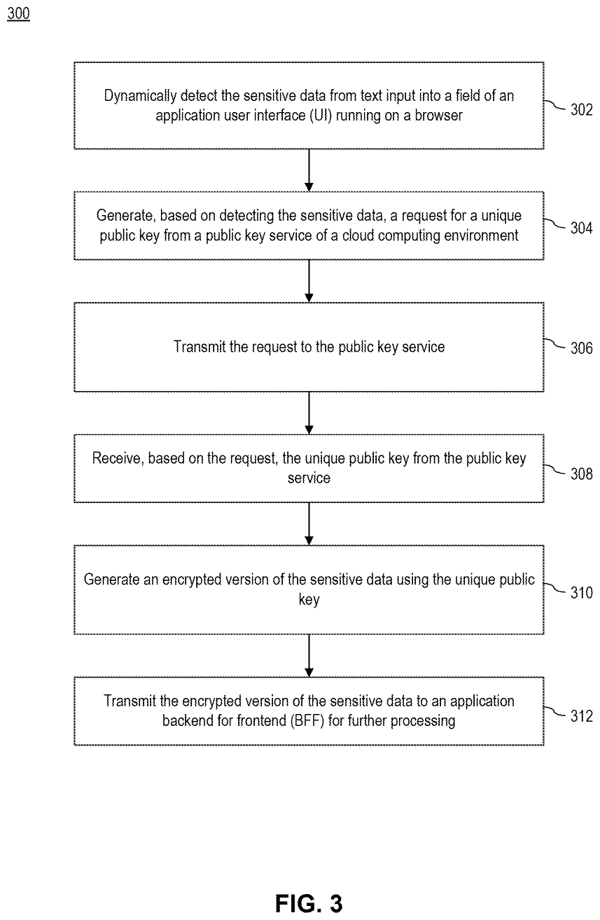

FIG. 3 shows an example method 300 of operating the system 100 in a number of embodiments of the present disclosure. Method 300 may be used when the key rotation service 104 is used to provide the public key 128 to the application frontend. In a number of embodiments, method 300 may be performed by the application frontend, which can utilize one or more computing devices to perform method 300. In a number of embodiments, the application frontend can dynamically detect the sensitive data 120 from text input into a field 116 of an application user interface (UI) 112 running on a browser 108, as shown in 302. Based on detecting the sensitive data 120, a request 122 may be generated for a unique public key 128 from a key rotation service 104 of a cloud computing environment 136, as shown in 304. The request 122 may be transmitted to the key rotation service 104, as shown in 306. Based on receipt of the request 122, the key rotation service 104 can transmit the public key 128 to the application frontend. The application frontend can receive the public key 128 from the key rotation service 104, as shown in 308. An encrypted version of the sensitive data 120 may be generated using the unique public key 128, as shown in 310. In a number of embodiments, the encrypted version of the sensitive data 120 may be transmitted to an application BFF 110 for further processing, as shown in 312.

In a number of embodiments, method 300 can perform the dynamic detection of the sensitive data 120 based on detecting a character string preceding the sensitive data 120, where the character string indicates the presence of the sensitive data 120. In a number of embodiments, the unique public key 128 may be linked to a unique private key 130 also generated by the key rotation service 104. The private key 130 may be used to decrypt the encrypted version of the sensitive data 120. In a number of embodiments, the public key 128 and the private key 130 may be EC keys.

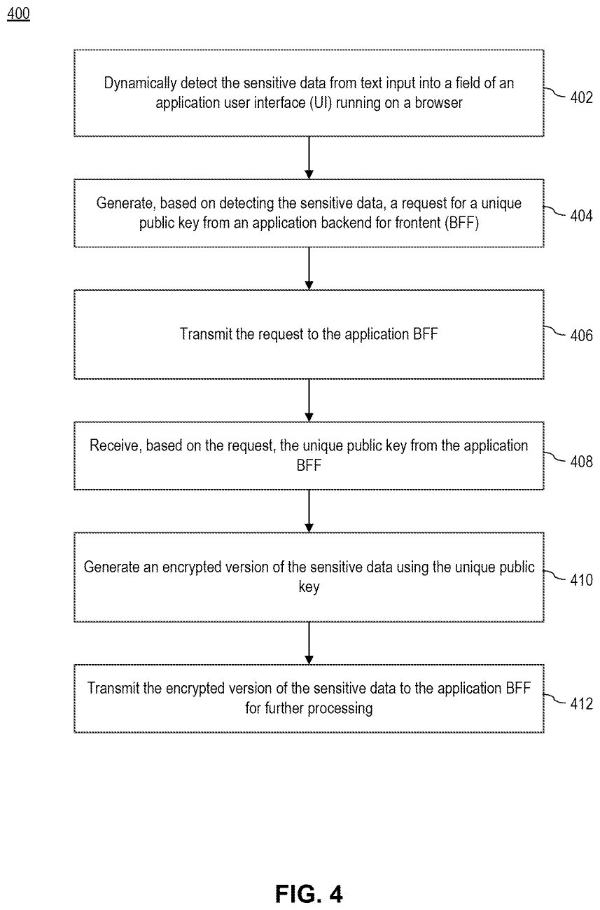

FIG. 4 shows an example method 400 of operating the system 200 in a number of embodiments of the present disclosure. Method 400 may be used when the application BFF 110 is used to provide the public key 204 to the application frontend. In a number of embodiments, method 400 may be performed by the application frontend, which can utilize one or more computing devices to perform method 400. In a number of embodiments, the application frontend can dynamically detect the sensitive data 120 from text input into a field 116 of an application user interface (UI) 112 running on a browser 108, as shown in 402. Based on detecting the sensitive data 120, a request 122 may be generated for a unique public key 204 from an application BFF 110, as shown in 404. The request 122 may be transmitted to the application BFF 110, as shown in 406. Based on receipt of the request 122, the application BFF 110 can transmit the public key 204 to the application frontend. The application frontend can receive the public key 204 from the application BFF 110, as shown in 408. An encrypted version of the sensitive data 120 may be generated using the unique public key 204, as shown in 410. In a number of embodiments, the encrypted version of the sensitive data 120 may be transmitted to the application BFF 110 for further processing, as shown in 412.

In a number of embodiments, method 400 can perform the dynamic detection of the sensitive data 120 based on detecting a character string preceding the sensitive data 120, where the character string indicates the presence of the sensitive data 120. In a number of embodiments, the unique public key 204 may be linked to a unique private key 206 also generated by the application BFF 110. The private key 206 may be used to decrypt the encrypted version of the sensitive data 120. In a number of embodiments, the public key 204 and the private key 206 may be EC keys.

The operations of methods 300 and 400 are performed, for example, by systems 100 and 200, in accordance with embodiments described above.

### Components of the System

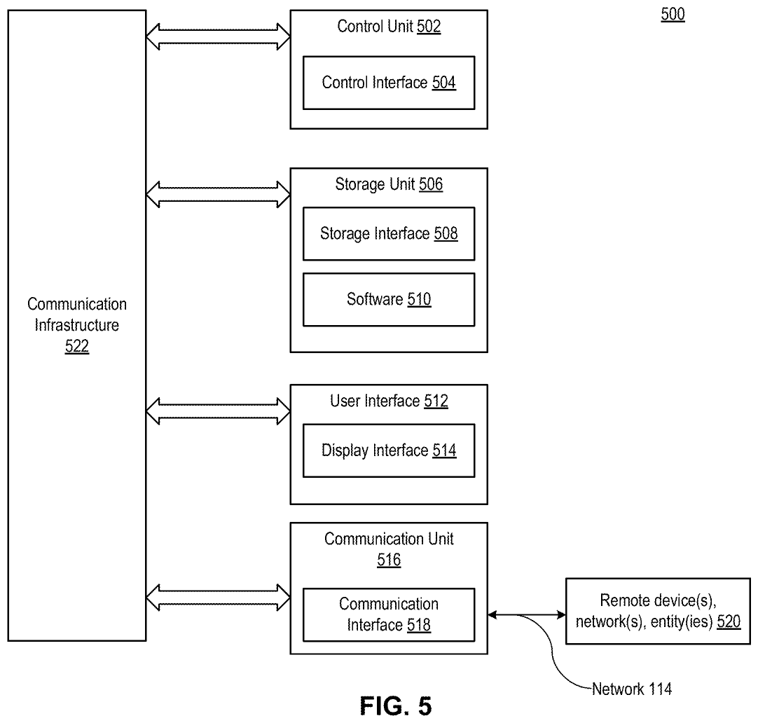

FIG. 5 shows an example architecture 500 of the components implementing systems 100 and 200 in embodiments of the present disclosure. The components may be used to implement the client device 102, the server 106, or the devices of the cloud computing environment 136. In a number of embodiments, the components may include a control unit 502, a storage unit 506, a communication unit 516, and a user interface 512. The control unit 502 may include a control interface 504. The control unit 502 may execute a software 510 to provide some or all of the intelligence of systems 100 and 200. The control unit 502 may be implemented in a number of different ways. For example, the control unit 502 may be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The control interface 504 may be used for communication between the control unit 502 and other functional units or devices of systems 100 and 200. The control interface 504 may also be used for communication that is external to the functional units or devices of systems 100 and 200. The control interface 504 may receive information from the functional units or devices of systems 100 and 200, or from remote devices 520, or may transmit information to the functional units or devices of systems 100 and 200, or to remote devices 520. The remote devices 520 refer to units or devices external to systems 100 and 200.

The control interface 504 may be implemented in different ways and may include different implementations depending on which functional units or devices of systems 100 and 200 or remote devices 520 are being interfaced with the control unit 502. For example, the control interface 504 may be implemented with a pressure sensor, an inertial sensor, a microelectromechanical system (MEMS), optical circuitry, waveguides, wireless circuitry, wireline circuitry to attach to a bus, an application programming interface, or a combination thereof. The control interface 504 may be connected to a communication infrastructure 522, such as a bus, to interface with the functional units or devices of systems 100 and 200 or remote devices 520.

The storage unit 506 may store the software 510. For illustrative purposes, the storage unit 506 is shown as a single element, although it is understood that the storage unit 506 may be a distribution of storage elements. Also for illustrative purposes, the storage unit 506 is shown as a single hierarchy storage system, although it is understood that the storage unit 506 may be in a different configuration. For example, the storage unit 506 may be formed with different storage technologies forming a memory hierarchical system including different levels of caching, main memory, rotating media, or off-line storage. The storage unit 506 may be a volatile memory, a nonvolatile memory, an internal memory, an external memory, or a combination thereof. For example, the storage unit 506 may be a nonvolatile storage such as nonvolatile random access memory (NVRAM), Flash memory, disk storage, or a volatile storage such as static random access memory (SRAM) or dynamic random access memory (DRAM).

The storage unit 506 may include a storage interface 508. The storage interface 508 may be used for communication between the storage unit 506 and other functional units or devices of systems 100 and 200. The storage interface 508 may also be used for communication that is external to systems 100 and 200. The storage interface 508 may receive information from the other functional units or devices of systems 100 and 200 or from remote devices 520 and/or may transmit information to the other functional units or devices of systems 100 and 200 or to remote devices 520. The storage interface 508 may include different implementations depending on which functional units or devices of systems 100 and 200 or remote devices 520 are being interfaced with the storage unit 506. The storage interface 508 may be implemented with technologies and techniques similar to the implementation of the control interface 504.

The communication unit 516 may enable communication to devices, components, modules, or units of systems 100 and 200 or to remote devices 520. For example, the communication unit 516 may permit the system 100 to communicate between the client device 102, the server 106, and the key rotation service 104. The communication unit 516 may permit system 200 to communicate between the client device 102 and the server 106. The communication unit 516 may further permit system 100 and 200 to communicate with remote devices 520 such as an attachment, a peripheral device, or a combination thereof through the network 114, such as a wireless or wired network.

The network 114 may span and represent a variety of networks and network topologies. For example, the network 114 may be a part of a network and include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 114. Cable, Ethernet, digital subscriber line (DSL), fiber optic lines, fiber to the home (FTTH), and plain old telephone service (POTS) are examples of wired communication that may be included in the network 114. Further, the network 114 may traverse a number of network topologies and distances. For example, the network 114 may include direct connection, personal area network (PAN), local area network (LAN), metropolitan area network (MAN), wide area network (WAN), or a combination thereof.

The communication unit 516 may also function as a communication hub allowing systems 100 and 200 to function as part of the network 114 and not be limited to be an end point or terminal unit to the network 114. The communication unit 516 may include active and passive components, such as microelectronics or an antenna, for interaction with the network 114.

The communication unit 516 may include a communication interface 518. The communication interface 518 may be used for communication between the communication unit 516 and other functional units or devices of systems 100 and 200 or to remote devices 520. The communication interface 518 may receive information from the other functional units or devices of systems 100 and 200, or from remote devices 520, or may transmit information to the other functional units or devices of the system 100 or to remote devices 520. The communication interface 518 may include different implementations depending on which functional units or devices are being interfaced with the communication unit 516. The communication interface 518 may be implemented with technologies and techniques similar to the implementation of the control interface 504.

The user interface 512 may present information generated by systems 100 and 200. In a number of embodiments, the user interface 512 allows a user of systems 100 and 200 to interface with the devices of systems 100 and 200 or remote devices 520. The user interface 512 may include an input device and an output device. Examples of the input device of the user interface 512 may include a keypad, buttons, switches, touchpads, soft-keys, a keyboard, a mouse, or any combination thereof to provide data and communication inputs. Examples of the output device may include a display interface 514. The control unit 502 may operate the user interface 512 to present information generated by systems 100 and 200. The control unit 502 may also execute the software 510 to present information generated by systems 100 and 200, or to control other functional units of systems 100 and 200. The display interface 514 may be any graphical user interface such as a display, a projector, a video screen, or any combination thereof.

The above detailed description and embodiments of the disclosed systems 100 and 200 are not intended to be exhaustive or to limit the disclosed systems 100 and 200 to the precise form disclosed above. While specific examples for systems 100 and 200 are described above for illustrative purposes, various equivalent modifications are possible within the scope of the disclosed systems 100 and 200, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting methods 300 and 400, and systems 100 and 200 are cost-effective, highly versatile, and accurate, and may be implemented by adapting components for ready, efficient, and economical manufacturing, application, and utilization. Another important aspect of embodiments of the present disclosure is that it valuably supports and services the historical trend of reducing costs, simplifying systems, and/or increasing performance.

These and other valuable aspects of the embodiments of the present disclosure consequently further the state of the technology to at least the next level. While the disclosed embodiments have been described as the best mode of implementing systems 100 and 200, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the scope of the invention should be determined not by the embodiments illustrated, but by the appended claims and their equivalents.

What is claimed is:

1. A computer implemented method for dynamic encryption of sensitive data, the method comprising:
dynamically detecting, by one or more computing devices, the sensitive data from text input into a field of an application user interface (UI) running on a browser;
generating, by the one or more computing devices and based on detecting the sensitive data, a request for a unique public key from a key rotation service of a cloud computing environment;
transmitting, by the one or more computing devices, the request to the key rotation service;
receiving, by the one or more computing devices and based on the request, the unique public key from the key rotation service;
generating, by the one or more computing devices, an encrypted version of the sensitive data using the unique public key; and
transmitting, by the one or more computing devices, the encrypted version of the sensitive data to an application backend for frontend (BFF) for further processing.

2. The method of claim 1, wherein dynamically detecting the sensitive data is based on detecting a character string preceding the sensitive data, the character string indicating the presence of the sensitive data.

3. The method of claim 1, wherein the sensitive data comprises at least a social security number.

4. The method of claim 1, wherein:
the unique public key is linked to a unique private key used by the application BFF to decrypt the encrypted version of the sensitive data; and
the unique public key and the unique private key are Elliptic Curve (EC) keys.

5. A computer implemented method for dynamic encryption of sensitive data, the method comprising:
dynamically detecting, by one or more computing devices, the sensitive data from text input into a field of an application user interface (UI) running on a browser;
generating, by the one or more computing devices and based on detecting the sensitive data, a request for a unique public key from an application backend for frontend (BFF);
transmitting, by the one or more computing devices, the request to the application BFF;
receiving, by the one or more computing devices and based on the request, the unique public key from the application BFF;
generating, by the one or more computing devices, an encrypted version of the sensitive data using the unique public key; and
transmitting, by the one or more computing devices, the encrypted version of the sensitive data to the application BFF for further processing.

6. The method of claim 5, wherein dynamically detecting the sensitive data is based on detecting a character string preceding the sensitive data, the character string indicating the presence of the sensitive data.

7. The method of claim 5, wherein the sensitive data comprises at least a social security number.

8. The method of claim 5, wherein:
the unique public key is linked to a unique private key used by the application BFF to decrypt the encrypted version of the sensitive data; and
the unique public key and the unique private key are Elliptic Curve (EC) keys.

9. A non-transitory computer readable medium including instructions for dynamic encryption of sensitive data, the instructions comprising:
dynamically detecting, by one or more computing devices, the sensitive data from text input into a field of an application user interface (UI) running on a browser;
generating, by the one or more computing devices and based on detecting the sensitive data, a request for a unique public key from a key rotation service of a cloud computing environment;
transmitting, by the one or more computing devices, the request to the key rotation service;
receiving, by the one or more computing devices and based on the request, the unique public key from the key rotation service;
generating, by the one or more computing devices, an encrypted version of the sensitive data using the unique public key;
transmitting, by the one or more computing devices, the encrypted version of the sensitive data to an application backend for frontend (BFF) for further processing; and
wherein dynamically detecting the sensitive data is based on detecting a character string preceding the sensitive data, the character string indicating the presence of the sensitive data.

10. The non-transitory computer readable medium of claim 9, wherein the sensitive data comprises at least a social security number.

11. The non-transitory computer readable medium of claim 9, wherein:
the unique public key is linked to a unique private key used by the application BFF to decrypt the encrypted version of the sensitive data; and
the unique public key and the unique private key are Elliptic Curve (EC) keys.

12. A non-transitory computer readable medium including instructions for dynamic encryption of sensitive data, the instructions comprising:
dynamically detecting, by one or more computing devices, the sensitive data from text input into a field of an application user interface (UI) running on a browser;
generating, by the one or more computing devices and based on detecting the sensitive data, a request for a unique public key from an application backend for frontend (BFF);
transmitting, by the one or more computing devices, the request to the application BFF;
receiving, by the one or more computing devices and based on the request, the unique public key from the application BFF;
generating, by the one or more computing devices, an encrypted version of the sensitive data using the unique public key;
transmitting, by the one or more computing devices, the encrypted version of the sensitive data to the application BFF for further processing; and
wherein dynamically detecting the sensitive data is based on detecting a character string preceding the sensitive data, the character string indicating the presence of the sensitive data.

13. The non-transitory computer readable medium of claim 12, wherein the sensitive data comprises at least a social security number.

14. The non-transitory computer readable medium of claim 12, wherein:
the unique public key is linked to a unique private key used by the application BFF to decrypt the encrypted version of the sensitive data; and
the unique public key and the unique private key are Elliptic Curve (EC) keys.

15. A computing system for dynamic encryption of sensitive data comprising:
a storage unit configured to store instructions;
a control unit, coupled to the storage unit, configured to process the stored instructions to:
dynamically detect the sensitive data from text input into a field of an application user interface (UI) running on a browser;
generate, based on detecting the sensitive data, a request for a unique public key from a key rotation service of a cloud computing environment;
a communication unit, coupled to the storage unit, configured to process the stored instructions to:
transmit the request to the key rotation service;
receive, based on the request, the unique public key from the key rotation service; and
wherein the control unit is further configured to generate an encrypted version of the sensitive data using the unique public key; and
wherein the communication unit is further configured to transmit the encrypted version of the sensitive data to an application backend for frontend (BFF) for further processing.

16. The computing system of claim 15, wherein the control unit is further configured to dynamically detect the sensitive data based on detecting a character string preceding the sensitive data, the character string indicating the presence of the sensitive data.

17. The computing system of claim 15, wherein the sensitive data includes at least a social security number.

18. The computing system of claim 15, wherein:
the unique public key is linked to a unique private key used by the application BFF to decrypt the encrypted version of the sensitive data; and
the unique public key and the unique private key are Elliptic Curve (EC) keys.

19. A computing system for dynamic encryption of sensitive data comprising:
a storage unit configured to store instructions;
a control unit, coupled to the storage unit, configured to process the stored instructions to:
dynamically detect the sensitive data from text input into a field of an application user interface (UI) running on a browser;
generate, based on detecting the sensitive data, a request for a unique public key from an application backend for frontend (BFF);
a communication unit, coupled to the storage unit, configured to process the stored instructions to:
transmit the request to the application BFF;
receive, based on the request, the unique public key from the application BFF; and
wherein the control unit is further configured to generate an encrypted version of the sensitive data using the unique public key; and
wherein the communication unit is further configured to transmit the encrypted version of the sensitive data to the application BFF for further processing.

20. The computing system of claim 19, wherein:
the control unit is further configured to dynamically detect the sensitive data based on detecting a character string preceding the sensitive data, the character string indicating the presence of the sensitive data; and
wherein:
the sensitive data includes at least a social security number;
the unique public key is linked to a unique private key used by the application BFF to decrypt the encrypted version of the sensitive data; and
the unique public key and the unique private key are Elliptic Curve (EC) keys.
